(19) United States
(12) Patent Application Publication
(10) Pub. No.: US 2025/0209976 A1
(43) Pub. Date: Jun. 26, 2025

(54) DISPLAY PANEL

(71) Applicant: Yungu (Gu’an) Technology Co., Ltd., Langfang (CN)

(72) Inventors: Xin ZHAO, Langfang (CN); Guangyuan SUN, Langfang (CN); Zhili MA, Langfang (CN); Genmao HUANG, Langfang (CN); Pei DUAN, Langfang (CN); Yongqiang LI, Langfang (CN)

(73) Assignee: Yungu (Gu’an) Technology Co., Ltd., Langfang (CN)

(21) Appl. No.: 19/074,418

(22) Filed: Mar. 9, 2025

(30) Foreign Application Priority Data
Mar. 26, 2024 (CN) 202410354855.8

(51) Int. Cl. G09G 3/32

(52) U.S. Cl. CPC G09G 3/32; G09G 2300/0819; G09G 2310/0267; G09G 2310/0286; G09G 2310/08; G09G 2320/0233

(57) ABSTRACT

The present disclosure discloses a display panel. The display panel includes clock signal line groups and gate drive circuits. Each clock signal line group includes a first clock signal line and a second clock signal line, and each gate drive circuit includes shift register units cascade-connected in sequence.

### CROSS REFERENCE TO RELATED APPLICATION

This application claims priority to Chinese Patent Application No. 202410354855.8, filed on Mar. 26, 2024, which is incorporated herein by reference in its entirety.

### FIELD

The present disclosure relates to the field of display technologies, and in particular, to a display panel, a display module, and a display apparatus.

### BACKGROUND ART

Active-matrix organic light emitting diode (AMOLED) display panels have unparalleled advantages over liquid crystal displays (LCDs) in display color saturation, response speed, power consumption, and foldability, and are gradually taking over the market for high-end mobile phones. However, such display panels still need to be improved.

### SUMMARY

The present disclosure provides a display panel.

According to embodiments of the present disclosure, a display panel is provided, including: pixels, including rows of pixels; clock signal line groups, each clock signal line group comprising a first clock signal line and a second clock signal line; gate drive circuits corresponding to the clock signal line groups, and each gate drive circuit comprises shift register units cascade-connected in sequence, each shift register unit is connected to at least one of the rows of pixels, and each shift register unit in each gate drive circuit is connected to the first clock signal line and the second clock signal line in the corresponding clock signal line group; and in the clock signal line groups, pulses of first clock signals transmitted on the first clock signal lines are sequentially delayed by a preset duration, and the pulses of the first clock signals transmitted on two adjacent first clock signal lines overlap; and in the clock signal line groups, pulses of second clock signals transmitted on the second clock signal lines are sequentially delayed by the preset duration, and the pulses of the second clock signals transmitted on two adjacent second clock signal lines overlap.

In one embodiment, each one of the pixels includes a pixel circuit including a first functional transistor, the shift register unit is configured to output a gate control signal to a first functional transistor of a pixel circuit in a row of pixels connected, and effective pulses of gate control signals output by shift register units connected to adjacent rows of pixels overlap. The shift register units connected to the adjacent rows of pixels are located in different gate drive circuits.

In one embodiment, the first functional transistor is a data write transistor.

In one embodiment, the pixel circuit further includes a first initialization transistor and a drive transistor, a first scanning signal output by an h^{th}-stage shift register unit to a first initialization transistor of a pixel circuit in an h^{th} row of pixels connected to the h^{th}-stage shift register unit is reused as a gate control signal received by a first functional transistor of a pixel circuit in an (h−2)^{th} row of pixels, where h is greater than or equal to 3.

Preferably, the first initialization transistor is configured to initialize a gate of a drive transistor in a pixel circuit.

In one embodiment, an effective pulse of a gate control signal output by the shift register unit connected to an n^{th} row of pixels and an effective pulse of a gate control signal output by the shift register unit connected to an (n+2)^{th} row of pixels are set at an interval, where n is a positive integer. The shift register unit connected to the n^{th} row of pixels and the shift register unit connected to the (n+2)^{th} row of pixels are located in the same gate drive circuit.

In one embodiment, the display panel includes f clock signal line groups and f gate drive circuits, and an (fm+q)^{th} row of pixels is connected to a q^{th} gate drive circuit, where m is an integer greater than or equal to 0, and q is a positive integer greater than or equal to 1 and less than or equal to f.

In one embodiment, each shift register unit includes a first clock signal terminal and a second clock signal terminal.

In a same gate drive circuit,
the first clock signal terminal of a (2i+1)^{th} shift register unit is connected to the first clock signal line in the clock signal line group corresponding to the gate drive circuit, and the second clock signal terminal of the (2i+1)^{th} shift register unit is connected to the second clock signal line in the clock signal line group corresponding to the gate drive circuit; and
the first clock signal terminal of a (2i+2)^{th} shift register unit is connected to the second clock signal line in the clock signal line group corresponding to the gate drive circuit, and the second clock signal terminal of the (2i+2)^{th} shift register unit is connected to the first clock signal line in the clock signal line group corresponding to the gate drive circuit, where i is an integer greater than or equal to 0.

In one embodiment, the display panel includes two clock signal line groups and two gate drive circuits, where one of the two gate drive circuits includes odd-numbered stage shift register units, and the other one of the two gate drive circuits includes even-numbered stage shift register units.

In one embodiment, each odd-numbered stage shift register unit is correspondingly connected to each odd-numbered row of pixels, and each even-numbered stage shift register unit is connected to each even-numbered row of pixels.

In one embodiment, a pulse of a first clock signal transmitted on the first clock signal line in the last clock signal line group is adjacent to and overlaps a pulse of a second clock signal transmitted on the second clock signal line in a first clock signal line group, and the pulse of the second clock signal transmitted on the second clock signal line in the first clock signal line group is delayed by preset duration compared with the pulse of the first clock signal transmitted on the first clock signal line in the last clock signal line group;
or a pulse of a second clock signal transmitted on the second clock signal line in the last clock signal line group is adjacent to and overlaps a pulse of a first clock signal transmitted on the first clock signal line in a first clock signal line group, and the pulse of the first clock signal transmitted on the first clock signal line in the first clock signal line group is delayed by preset duration compared with the pulse of the second clock signal transmitted on the second clock signal line in the last clock signal line group.

In one embodiment, duration of the effective pulse of the gate control signal is greater than a row period, where the row period is equal to 1/refresh rate/equivalent number of rows of subpixels.

In one embodiment, the display panel further includes gate lines, first data lines, and second data lines, and the pixels comprising columns of pixels, and the shift register unit is connected to a row of pixels through the gate line transmitting a gate control signal to a pixel circuit in the pixel.

In a column of pixels, pixels in odd-numbered rows are connected to the same first data line, and pixels in even-numbered rows are connected to the same second data line.

In one embodiment, the display panel further includes a time division multiplexing circuit, the time division multiplexing circuit includes input terminals and output terminal groups, one input terminal corresponds to at least one output terminal group, the output terminal group includes two output terminals respectively connected to the first data line and the second data line, and the first data line and the second data line connected to the same output terminal group are connected to the same column of pixels.

The time division multiplexing circuit is configured to control each input terminal to transmit a data voltage to each corresponding output terminal in a time division manner.

In one embodiment, the time division multiplexing circuit comprises time division multiplexing modules, the time division multiplexing module comprises at least one time division multiplexing unit, the time division multiplexing unit is connected to one input terminal and one output terminal group, and each time division multiplexing unit in the same time division multiplexing module is connected to the same input terminal.

The time division multiplexing circuit further comprises at least one gating signal line group, and one time division multiplexing unit is connected to one gating signal line group. The gating signal line group includes a first gating signal line and a second gating signal line. A gating signal transmitted on the first gating signal line is used to control whether the input terminal is connected to a corresponding first data line, and a gating signal transmitted on the second gating signal line is used to control whether the input terminal is connected to a corresponding second data line.

In one embodiment, the time division multiplexing module comprises at least two time division multiplexing units, and different time division multiplexing units in the same time division multiplexing module are connected to different gating signal line groups.

In one embodiment, during a process of writing data voltages corresponding to two adjacent rows of pixels into the first data line and the second data line, pulses of gating signals transmitted on the first gating signal lines in each gating signal line group are adjacent, and pulses of gating signals transmitted on the second gating signal lines in each gating signal line group are adjacent.

In one embodiment, in the same time division multiplexing module, a pulse of the gating signals transmitted on the first gating signal line connected to the last time division multiplexing unit is adjacent to a pulse of the gating signals transmitted on the second gating signal line connected to a first time division multiplexing unit.

In one embodiment, pixel columns corresponding to time division multiplexing units in the same time division multiplexing module are arranged in sequence.

In one embodiment, an end moment of the effective pulse of the gate control signal received by the data write transistor of the pixel circuit in an n^{th} row of pixels coincides with or is earlier than a first moment at which a k^{th} data line and a corresponding input terminal begin to connect to transmit a data signal corresponding to an (n+2)^{th} row of pixels, and n is a positive integer; and n is an odd number, the k^{th} data line is the first data line; or n is an even number, the k^{th} data line is the second data line.

In one embodiment, a time period during which an e^{th} data line and a corresponding input terminal connect to transmit a data signal corresponding to an (n+1)^{th} row of pixels is within a time period during which the gate control signal received by the data write transistor of the pixel circuit in the n^{th} row of pixels has the effective pulse; and n is an odd number, the e^{th} data line is the second data line; or n is an even number, the e^{th} data line is the first data line.

In one embodiment, the time period during which the gate control signal received by the data write transistor of the pixel circuit in the n^{th} row of pixels has the effective pulse overlaps a first time period during which the k^{th} data line and the corresponding input terminal connect to transmit a data signal corresponding to an n^{th} row of pixels.

In one embodiment, the effective pulse of the gate control signal received by the data write transistor of the pixel circuit in the n^{th} row of pixels overlaps a first effective pulse of the last k^{th} gating signal line, the first effective pulse of the last k^{th} gating signal line is located within the first time period, and the last k^{th} gating signal line is the k^{th} gating signal line connected to the last time division multiplexing unit in the same time division multiplexing module.

In one embodiment, a start moment of the effective pulse of the gate control signal received by the data write transistor of the pixel circuit in the n^{th} row of pixels is later than or coincides with a start moment of the first effective pulse of the last k^{th} gating signal line.

In one embodiment, a difference between pulse widths of gating signals transmitted on any two gating signal lines is less than a set width threshold.

According to another embodiment of the present disclosure, another display panel is provided, including: pixels, comprising rows of pixels; and gate drive circuits.

Each gate drive circuit includes shift register units cascade-connected in sequence, and each shift register unit is connected to at least one row of pixels. The shift register unit is configured to output a gate control signal to a row of pixels connected, and effective pulses of gate control signals output by the shift register units connected to adjacent rows of pixels overlap.

According to still another embodiment of the present disclosure, a display module is provided, including the display panel according to any one of the above.

According to yet another embodiment of the present disclosure, a display apparatus is provided, including the display module described above.

In the embodiments, in the clock signal line groups, the pulses of the clock signals transmitted on the first clock signal lines are sequentially delayed by preset duration and the pulses of the clock signals transmitted on two adjacent first clock signal lines overlap, and the pulses of the clock signals transmitted on the second clock signal lines are sequentially delayed by preset duration and the pulses of the clock signals transmitted on two adjacent second clock signal lines overlap, and pulses of gate control signals output by the same-stage shift register units in adjacent gate drive circuits to corresponding rows of pixels overlap, and the data voltage is written into the adjacent rows of pixels simultaneously for at least some duration, to increase the time for writing the data voltage and improving the display effect.

It should be understood that the content described in this section is not intended to identify critical or important features of the embodiments of the present disclosure, or is not intended to limit the scope of the present disclosure. Other features of the present disclosure are easily understood through the following description.

### BRIEF DESCRIPTION OF THE DRAWINGS

To describe the embodiments of the present disclosure more clearly, the following briefly describes the accompanying drawings required for describing the embodiments. The accompanying drawings in the following description show merely some embodiments of the present disclosure.

FIG. 1 is a schematic diagram of an image sticking phenomenon of an existing display panel;

FIG. 2 is a schematic diagram of a structure of a display panel according to an embodiment of the present disclosure;

FIG. 3 is a schematic diagram of a structure of a pixel circuit according to an embodiment of the present disclosure;

FIG. 4 is a timing sequence diagram of clock signals connected to different clock signal line groups in a display panel according to an embodiment of the present disclosure;

FIG. 5 is a schematic diagram of a structure of another display panel according to an embodiment of the present disclosure;

FIG. 6 is a timing sequence diagram of clock signals connected to different clock signal line groups in another display panel according to an embodiment of the present disclosure;

FIG. 7 is a schematic diagram of a structure of a shift register unit according to an embodiment of the present disclosure;

FIG. 8 is a driving timing sequence diagram of a shift register unit according to an embodiment of the present disclosure;

FIG. 9 is a driving timing sequence diagram of a display panel according to an embodiment of the present disclosure; and

FIG. 10 is a schematic diagram of a structure of a display apparatus according to an embodiment of the present disclosure.

### DETAILED DESCRIPTION OF EMBODIMENTS

The embodiments of the present disclosure will be clearly and completely described below with reference to the accompanying drawings in the embodiments of the present disclosure. The described embodiments are merely some rather than all of the embodiments of the present disclosure.

It should be noted that the terms “first”, “second”, etc. in the specification, claims, and accompanying drawings of the present disclosure are intended to distinguish between similar objects but do not necessarily indicate a specific order or sequence. It should be understood that data used in such a way is interchangeable in a proper circumstance, and embodiments of the present disclosure described herein can be implemented in other orders than the order illustrated or described herein. Moreover, the terms “include”, “contain” and any variant thereof are intended to cover a non-exclusive inclusion. For example, a process, method, system, product, or device that includes a list of steps or units is not necessarily limited to those steps or units that are expressly listed, but may include other steps or units not expressly listed or are inherent to the process, method, product, or device.

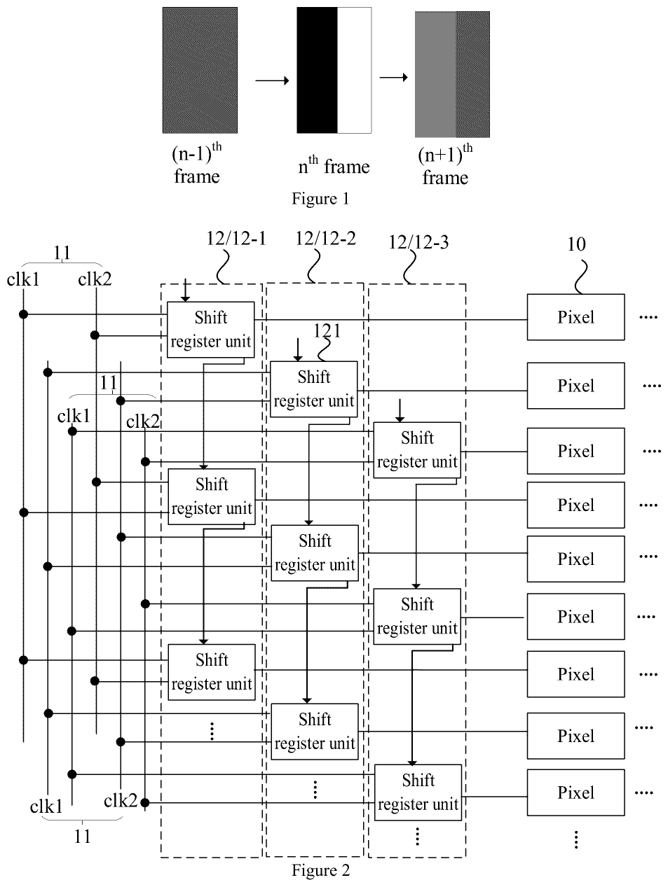

As described in the background, image sticking may be prone to occur when a refresh rate is low or when the number of memories in a display apparatus is reduced to reduce costs of an AMOLED display apparatus. The inventor has found through research that the reason for this is that the above situation causes a reduction in charging time, which in turn results in image sticking and uneven display. FIG. 1 is a schematic diagram of an image sticking phenomenon of an existing display panel. Referring to FIG. 1, during a performance test process of the display panel, the display panel is set to display brightness corresponding to a gray scale of 48 in an entire display area in an (n−1)^{th} frame, display a black-and-white image (e.g., a black block with a gray scale of 0 and a white block with a gray scale of 255) in an n^{th} frame and maintain it for preset time (e.g., 10 s), and display the brightness corresponding to the gray scale of 48 in the entire display area in an (n+1)^{th} frame, which causes a large data voltage difference since both the gray scale of 0 and the gray scale of 255 differ greatly from the gray scale of 48. Therefore, when charging time is shortened, a data voltage written in the (n+1)^{th} frame is insufficient, resulting in image sticking. Due to the image sticking of the black-and-white image, in a final displayed image, the original black block is less bright than the original white block, reflected as the part of the original black block being lighter than the part of the original white block. That is, image sticking occurs in the display panel, which affects the display effect of the display panel.

For the above embodiments of the present disclosure provides a new display panel, to increase duration for writing a data voltage and improve the display effect. FIG. 2 is a schematic diagram of a structure of a display panel according to an embodiment of the present disclosure. Referring to FIG. 2, the display panel includes: pixels 10, clock signal line groups 11, and gate drive circuits 12 corresponding to the clock signal line groups 11.

Each clock signal line group 11 includes a first clock signal line clk1 and a second clock signal line clk2, each gate drive circuit 12 includes shift register units 121 cascade-connected in sequence, and each shift register unit 121 is connected to at least one row of pixels 10.

Each shift register unit 121 in each gate drive circuit 12 is connected to the first clock signal line clk1 and the second clock signal line clk2 in the corresponding clock signal line group 11.

In the clock signal line groups 11, pulses of clock signals transmitted on the first clock signal lines clk1 are sequentially delayed by preset duration, and pulses of clock signals transmitted on two adjacent first clock signal lines clk1 in timing sequence overlap. Each of the clock signals transmitted on the first clock signal lines clk1 is a first clock signal.

In the clock signal line groups 11, pulses of clock signals transmitted on the second clock signal lines clk2 are sequentially delayed by preset duration, and pulses of clock signals transmitted on two adjacent second clock signal lines clk2 in timing sequence overlap. Each of the clock signals transmitted on the second clock signal lines clk2 is a second clock signal.

The display panel includes pixels 10 arranged in an array, the pixels 10 includes rows of pixels and columns of pixels. One pixel 10 may include at least one subpixel, and one subpixel may be correspondingly connected to one pixel circuit, to drive the subpixel to emit light; Or, each one of the pixels includes a pixel circuit and a light emitting device. The present disclosure regards pixels including pixel circuits arranged in a row as the row of pixels. In other words, the row of pixels includes pixels, pixel circuits of which are arranged in a row.

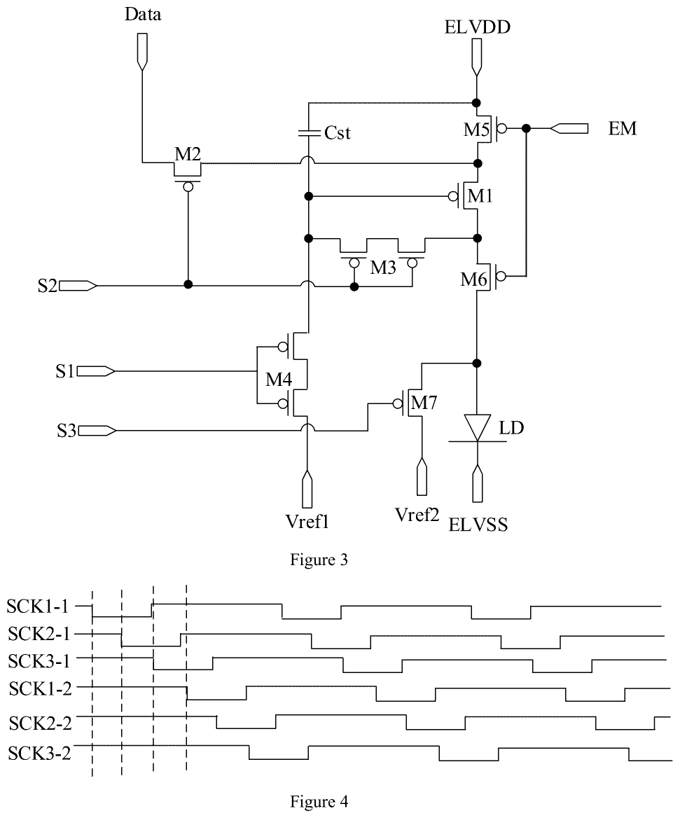

FIG. 3 is a schematic diagram of a structure of a pixel circuit according to an embodiment of the present disclosure. Referring to FIG. 3, the pixel circuit includes a storage capacitor Cst, a drive transistor M1, a data write transistor M2, a compensation transistor M3, a first initialization transistor M4, a first light emission control transistor M5, a second light emission control transistor M6, and a second initialization transistor M7. The first light emission control transistor M5, the drive transistor M1, the second light emission control transistor M6, and a light emitting device LD are series-connected in sequence between a first power supply ELVDD and a second power supply ELVSS, the data write transistor M2 is connected between a data line Data and a first electrode of the drive transistor M1, the compensation transistor M3 is connected between a second electrode and a gate of the drive transistor M1, the first initialization transistor M4 is connected between a first initialization signal line Vref1 and the gate of the drive transistor M1, and the second initialization transistor M7 is connected between a second initialization signal line Vref2 and a first electrode of the light emitting device LD. A gate of the first initialization transistor M4 receives a first scanning signal S1, a gate of the data write transistor M2 and a gate of the compensation transistor M3 receive a second scanning signal S2, a gate of the second initialization transistor M7 is connected to a third scanning signal S3, and gates of the first light emission control transistor M5 and the second light emission control transistor M6 receive a light emission control signal EM. A 7T1C pixel circuit is used as an example in this embodiment, and a 5T1C pixel circuit or the like may be used as an example in other embodiments, which is not specifically limited. Each gate drive circuit 12 includes shift register units 121 cascade-connected in sequence, each gate drive circuit 12 is connected to a clock signal line group 11, the shift register units 121 in different gate drive circuits 12 are connected to different clock signal line groups 11, and the shift register units 121 included in the same gate drive circuit 12 are connected to the same first clock signal line clk1 and second clock signal line clk2. The shift register unit 121 is configured to output a gate control signal, where the gate control signal may be the first scanning signal S1, the second scanning signal S2, or the third scanning signal S3 that is connected to the pixel circuit. Each shift register unit 121 is connected to at least one row of pixels 10. For example, one shift register unit 121 is connected to one row of pixels 10, and the shift register unit 121 outputs the second scanning signal S2 for controlling the data write transistor M2 and the compensation transistor M3 to be conducted to the row of pixels 10 connected. Alternatively, except that a first-stage shift register unit and a last-stage shift register unit each are connected to one row of pixels 10, each of the remaining shift register units 121 is connected to two rows of pixels 10, and the first scanning signal S1 and the second scanning signal S2 may be generated by the same group of gate drive circuits 12, which is conducive to achieving a narrow bezel. The first-stage shift register unit 121 and the last-stage shift register unit 121 do not refer to a first-stage shift register unit and a last-stage shift register unit in a single gate drive circuit, but refer to a first-stage shift register unit and a last-stage shift register unit of all shift register units in all gate drive circuits.

FIG. 4 is a timing sequence diagram of clock signals connected to different clock signal line groups in a display panel according to an embodiment of the present disclosure. FIG. 4 includes six clock signals. A first clock signal SCK1-1 is a clock signal provided on the first clock signal line clk1 connected to the first gate drive circuit 12-1. A second clock signal SCK2-1 is a clock signal provided on the first clock signal line clk1 connected to the second gate drive circuit 12-2. A third clock signal SCK3-1 is a clock signal provided on the first clock signal line clk1 connected to the third gate drive circuit 12-3. A fourth clock signal SCK1-2 is a clock signal provided on the second clock signal line clk2 connected to the first gate drive circuit 12-1 in timing sequence. A fifth clock signal SCK2-2 is a clock signal provided on the second clock signal line clk2 connected to the second gate drive circuit 12-2. A sixth clock signal SCK3-2 is a clock signal provided on the second clock signal line clk2 connected to the third gate drive circuit 12-3. In different gate drive circuits 12, pulses of clock signals provided on the first clock signal lines clk1 are sequentially delayed by preset duration, and pulses of clock signals provided on the second clock signal lines clk2 are sequentially delayed by preset duration. In two adjacent gate drive circuits 12, pulses of clock signals provided on the first clock signal lines clk1 partially overlap, and pulses of clock signals provided on the second clock signal lines clk2 partially overlap. In one embodiment, in the clock signal line groups, a pulse of a clock signal transmitted on the first clock signal line clk1 in the last clock signal line group in timing sequence is adjacent to and overlaps a pulse of a clock signal transmitted on the second clock signal line clk2 in the first clock signal line group in timing sequence, and a pulse of a clock signal transmitted on the second clock signal line clk2 in the first clock signal line group in timing sequence is delayed by preset duration compared with a pulse of a clock signal transmitted on the first clock signal line clk1 in the last clock signal line group in timing sequence. Alternatively, a pulse of a clock signal transmitted on the second clock signal line clk2 in the last clock signal line group in timing sequence is adjacent to and overlaps a pulse of a clock signal transmitted on the first clock signal line clk1 in the first clock signal line group in timing sequence, and a pulse of a clock signal transmitted on the first clock signal line clk1 in the first clock signal line group in timing sequence is delayed by preset duration compared with a pulse of a clock signal transmitted on the second clock signal line clk2 in the last clock signal line group in timing sequence. The last clock signal line group is a clock signal line group to which a first clock signal line corresponding to the last clock signal in timing sequence of all clock signals on the first clock signal lines belongs, or a clock signal line group to which a second clock signal line corresponding to the last clock signal in timing sequence of all clock signals on the second clock signal lines belongs. Similarly, the first clock signal line group is a clock signal line group to which a first clock signal line corresponding to the first clock signal in timing sequence of all clock signals on the first clock signal lines belongs, or a clock signal line group to which a second clock signal line corresponding to the first clock signal in timing sequence of all clock signals on the second clock signal lines belongs. As shown in FIG. 4, an example in which a pulse of the clock signal SCK1-2 transmitted on the second clock signal line clk2 in the first clock signal line group in timing sequence is delayed by preset duration from a pulse of the clock signal SCK3-1 transmitted on the first clock signal line clk1 in the last clock signal line group (the third clock signal line group) in timing sequence is used. As shown in FIG. 4, in timing sequence: a pulse of the clock signal SCK1-1 transmitted on the first clock signal line clk1 in the first clock signal line group, a pulse of the clock signal SCK2-1 transmitted on the first clock signal line clk1 in the second clock signal line group, a pulse of the clock signal SCK3-1 transmitted on the first clock signal line clk1 in the third clock signal line group, a pulse of the clock signal SCK1-2 transmitted on the second clock signal line clk2 in the first clock signal line group, a pulse of the clock signal SCK2-2 transmitted on the second clock signal line clk2 in the second clock signal line group, and a pulse of the clock signal SCK3-2 transmitted on the second clock signal line clk2 in the third clock signal line group are sequentially delayed by preset duration, and adjacent shift register units 121 generate regular gate control signals shown in FIG. 4. In one embodiment, if the display panel includes R gate drive circuits, the preset duration is greater than or equal to one-Rth of duration of an effective pulse of the clock signal transmitted on the first clock signal line or the second clock signal line. The effective pulse of the clock signal has a same potential as an effective pulse of the gate control signal. For example, the effective pulse of the clock signal is a low-level pulse.

In one embodiment, the shift register unit 121 is configured to output a gate control signal to a first functional transistor of a pixel circuit in a row of pixels 10 connected, effective pulses of gate control signals output by shift register units 121 connected to adjacent rows of pixels 10 overlap, and the shift register units 121 connected to the adjacent rows of pixels 10 are located in different gate drive circuits. Within one frame, the pulse of the gate control signal output by the shift register unit 121 completely overlaps one pulse of one of the clock signal on the first clock signal line clk1 connected to the shift register unit 121 and the clock signal on the second clock signal line clk2, and two adjacent rows of pixels are connected to two adjacent gate drive circuits 12. Therefore, in two adjacent gate drive circuits 12, when the pulses of the clock signals provided on the first clock signal lines clk1 partially overlap, and the pulses of the clock signals provided on the second clock signal lines clk2 partially overlap, the gate control signals connected to the two adjacent rows of pixels 10 partially overlap. In one embodiment, the first functional transistor is the data write transistor in FIG. 3, and the gate control signal is a signal for controlling the writing of a data voltage into the drive transistor in the pixel circuit, and is, corresponding to the pixel circuit shown in FIG. 3, the second scanning signal S2. Pulses of the second scanning signals S2 connected to two adjacent rows of pixels overlap, and in a case of limited time for writing the data voltage at a low frequency, the writing of the data voltage into a next row of pixels may be started during the writing of the data voltage into a previous row of pixels, to increase the time for writing the data voltage. In this way, the writing of the data voltage is more sufficient, uneven display and image sticking are alleviated, and the display effect is improved.

In one embodiment, an effective pulse of a gate control signal output by the shift register unit 121 connected to an n^{th} row of pixels and an effective pulse of a gate control signal output by the shift register unit 121 connected to an (n+2)^{th} row of pixels are set at an interval, where n is a positive integer, and the shift register unit 121 connected to the n^{th} row of pixels and the shift register unit 121 connected to the (n+2)^{th} row of pixels are located in the same gate drive circuit 12. The shift register unit 121 connected to the n^{th} row of pixels and the shift register unit 121 connected to the (n+2)^{th} row of pixels may be two adjacent shift register units 121 cascade-connected. The shift register unit 121 connected to the (n+2)^{th} row of pixels outputs the effective pulse of the gate control signal only after an interval of specific duration since the shift register unit 121 connected to the nth row of pixels outputs the effective pulse of the gate control signal, and the effective pulses of the gate control signals of the shift register units cascade-connected are output step by step in the same gate drive circuit. In one embodiment, the effective pulse of the gate control signal output by the shift register unit connected to the n^{th} row of pixels and an effective pulse of a gate control signal output by the shift register unit connected to an (n+3)^{th} row of pixels are set at an interval. The display panel includes f clock signal line groups and f gate drive circuits, and an (fm+q)^{th} row of pixels are connected to a q^{th} gate drive circuit, where m is an integer greater than or equal to 0, and q is a positive integer greater than or equal to 1 and less than or equal to f. In this embodiment, as an example, f=3, that is, the display panel includes three clock signal line groups 11 and three gate drive circuits 12, the first gate drive circuit 12-1 is connected to a (3m+1)^{th} row of pixels, the second gate drive circuit 12-2 is connected to a (3m+2)^{th} row of pixels, and the third gate drive circuit 12-3 is connected to a (3m+3)^{th} row of pixels, where m=0, 1, 2, . . . m is an integer. In other embodiments, other numbers of clock signal line groups and gate drive circuits 12 may be included, which is not specifically limited.

In the embodiments, in the clock signal line groups, the pulses of the clock signals transmitted on the first clock signal lines are sequentially delayed by preset duration and the pulses of the clock signals transmitted on two adjacent first clock signal lines in timing sequence overlap, and the pulses of the clock signals transmitted on the second clock signal lines are sequentially delayed by preset duration and the pulses of the clock signals transmitted on two adjacent second clock signal lines in timing sequence overlap, and pulses of gate control signals output by the same-stage shift register units in adjacent gate drive circuits to corresponding rows of pixels overlap, and the data voltage is written into the adjacent rows of pixels simultaneously for at least some duration, to increase the time for writing the data voltage and improving the display effect.

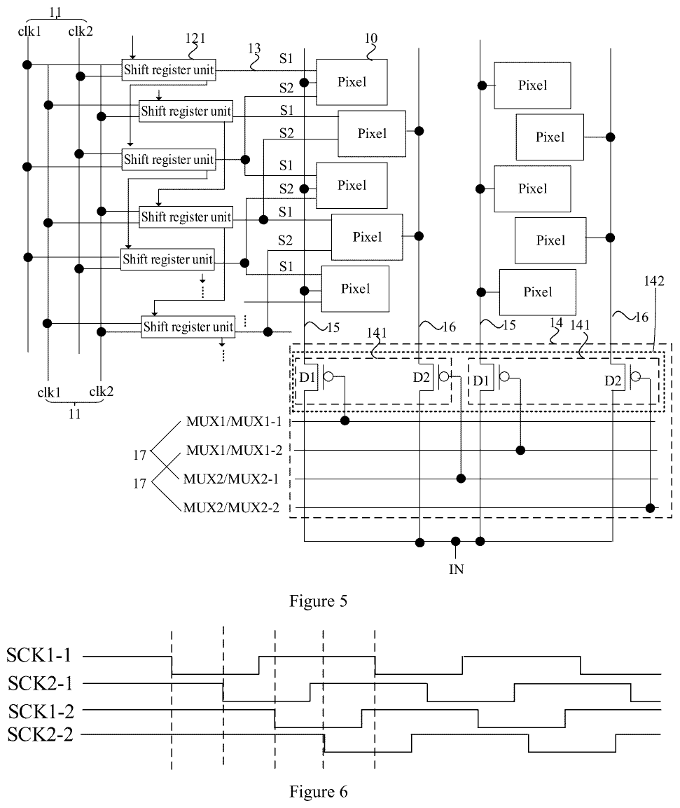

FIG. 5 is a schematic diagram of a structure of another display panel according to an embodiment of the present disclosure. Referring to FIG. 5 and FIG. 6, in one embodiment, each shift register unit 121 includes a first clock signal terminal and a second clock signal terminal.

In a same gate drive circuit,
the first clock signal terminal of a (2i+1)^{th} shift register unit is connected to a first clock signal line clk1 in a clock signal line group 11 corresponding to the gate drive circuit, and the second clock signal terminal is connected to a second clock signal line clk2 in the clock signal line group 11 corresponding to the gate drive circuit 12; and
the first clock signal terminal of a (2i+2)^{th} shift register unit is connected to the second clock signal line clk2 in the clock signal line group 11 corresponding to the gate drive circuit, and the second clock signal terminal is connected to the first clock signal line clk1 in the clock signal line group 11 corresponding to the gate drive circuit, where i is an integer greater than or equal to 0.

For the shift register units 121 in the same gate drive circuit, the first clock signal terminals of the shift register units in odd-numbered rows are all connected to the first clock signal lines clk1, and the second clock signal terminals are all connected to the second clock signal lines clk1, and the shift register units in the odd-numbered rows shift and output gate control signals step by step. The first clock signal terminals of the shift register units in even-numbered rows are all connected to the second clock signal lines clk2, and the second clock signal terminals are all connected to the first clock signal lines clk1, and the shift register units in the even-numbered rows shift and output gate control signals step by step.

In one embodiment, pulses of clock signals on the first clock signal lines clk1 in different clock signal line groups are sequentially delayed, pulses of clock signals on the second clock signal lines clk2 in different clock signal line groups are sequentially delayed, and in the clock signal line groups, the pulse of the clock signal transmitted on the first clock signal line in the last clock signal line group is adjacent to and partially overlaps the pulse of the clock signal transmitted on the second clock signal line in a first clock signal line group in timing sequence. Therefore, under driving of the timing sequence of the above clock signals, effective pulses of gate control signals output by shift register units 121 of two adjacent stages connected to two adjacent rows of pixels partially overlap.

FIG. 6 is a timing sequence diagram of clock signals connected to

different clock signal line groups in another display panel according to an embodiment of the present disclosure. Referring to FIG. 5 and FIG. 6, in one embodiment, the display panel includes two clock signal line groups 11 and two gate drive circuits. One gate drive circuit of the two gate drive circuits includes odd-numbered stage shift register units, and the other gate drive circuit of the two gate drive circuits includes even-numbered stage shift register units. Each odd-numbered stage shift register unit is correspondingly connected to each odd-numbered row of pixels, and each even-numbered stage shift register unit is correspondingly connected to each even-numbered row of pixels. The “odd-numbered stage shift register unit” does not refer to an odd-numbered stage shift register unit in a single gate drive circuit, and the “even-numbered stage shift register unit” does not refer to an even-numbered stage shift register unit in a single gate drive circuit. For example, one row of pixels 10 correspond to one shift register unit 121, and the shift register unit 121 is configured to output a gate control signal for controlling the data write transistor M2 in FIG. 3 to be conducted, namely the second scanning signal S2. In this case, the odd-numbered stage shift register unit is the shift register unit 121 corresponding to the odd-numbered row of pixels, and the even-numbered stage shift register unit is the shift register unit 121 corresponding to the even-numbered row of pixels. That is, regardless of the odd-numbered stage shift register unit or the even-numbered stage shift register unit, all shift register units 121 in all gate drive circuits are considered as a whole. In this embodiment, as an example, the display panel includes two gate drive circuits and two clock signal line groups. In timing sequence, a first clock signal SCK1-1 is transmitted on the first clock signal line clk1 in the first clock signal line group, and a second clock signal SCK1-2 is transmitted on the second clock signal line clk2. In timing sequence, a third clock signal SCK2-1 is transmitted on the first clock signal line clk1 in a second clock signal line group, and a fourth clock signal SCK2-2 is transmitted on the second clock signal line clk2. Pulses of the first clock signal SCK1-1, the third clock signal SCK2-1, the second clock signal SCK1-2, and the fourth clock signal SCK2-2 are sequentially delayed by preset duration.

The odd-numbered stage shift register unit is configured to output a scanning signal (e.g., the second scanning signal S2 in FIG. 3) for controlling the data write transistor M2 to be conducted to an odd-numbered row of pixel circuits, and the even-numbered stage shift register unit is configured to output a scanning signal for controlling the data write transistor M2 to be conducted to an even-numbered row of pixel circuits. The writing of a data voltage into the odd-numbered row of pixels and the even-numbered row of pixels is achieved by driving the odd-numbered row of pixels and the even-numbered row of pixels respectively by two groups of gate drive circuits.

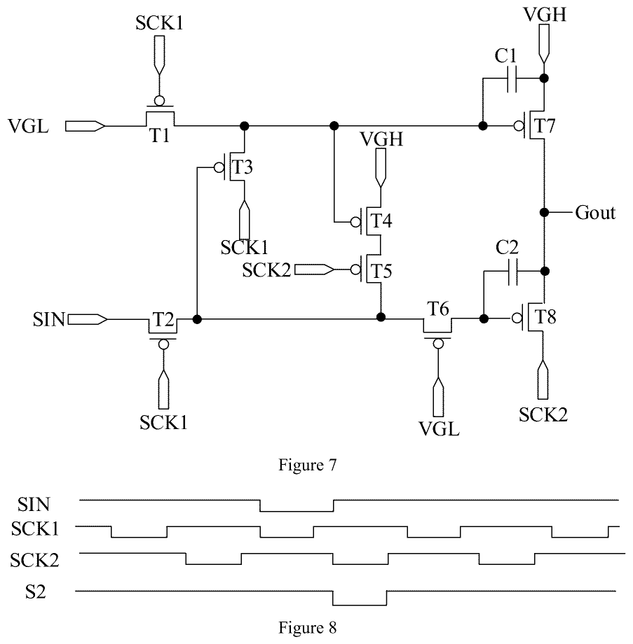

FIG. 7 is a schematic diagram of a structure of a shift register unit according to an embodiment of the present disclosure, and FIG. 8 is a driving timing sequence diagram of a shift register unit according to an embodiment of the present disclosure. Referring to FIG. 5, FIG. 7, and FIG. 8, in one embodiment, the shift register unit 121 includes a total of eight transistors and two capacitors. A first electrode of the first transistor T1 is connected to a first potential VGL, a second electrode of the first transistor T1 is connected to a gate of the seventh transistor T7, and a gate of the first transistor T1 is used as a first clock signal terminal. A first electrode of the second transistor T2 is connected to a start signal SIN, a second electrode of the second transistor T2 is connected to a first electrode of the sixth transistor T6, and a gate of the second transistor T2 is used as a first clock signal terminal. A first electrode of the third transistor T3 is used as a first clock signal terminal, a second electrode of the third transistor T3 is connected to the gate of the seventh transistor T7, and a gate of the third transistor T3 is connected to the first electrode of the sixth transistor T6. A fourth transistor T4 and a fifth transistor T5 are series-connected in sequence between a second potential VGH and the first electrode of the sixth transistor T6, a gate of the fourth transistor T4 is connected to the gate of the seventh transistor T7, and a gate of the fifth transistor T5 is used as a second clock signal terminal. A second electrode of the sixth transistor T6 is connected to a gate of the eighth transistor T8, and a gate of the sixth transistor T6 is connected to the first potential VGL. A first electrode of the seventh transistor T7 is connected to the second potential VGH, and a second electrode of the seventh transistor T7 is used as an output terminal Gout, to output a gate control signal. A first electrode of the eighth transistor T8 is used as a second clock signal terminal, and a second electrode of the eighth transistor T8 is used as the output terminal Gout. A first capacitor C1 is connected between the first electrode and the gate of the seventh transistor T7, and a second capacitor C2 is connected between the second electrode and the gate of the eighth transistor T8. In this embodiment, an example in which two clock signal line groups and two gate drive circuits are included is used, and as an example, the shift register unit in FIG. 7 is a first-stage shift register unit corresponding to a first row of pixels, the first clock signal terminal is connected to the first clock signal line clk1 in the first clock signal line group, and the second clock signal terminal is connected to the second clock signal line clk2 in the first clock signal line group. Pulses of a first clock signal SCK1 output on the first clock signal line clk1 and a second clock signal SCK2 output on the second clock signal line clk2 are sequentially delayed and output. Under driving of a timing sequence shown in FIG. 8, the output terminal Gout of the shift register unit 121 outputs the second scanning signal S2 to the first row of pixels.

Still referring to FIG. 5, in one embodiment, the display panel further includes gate lines 13, first data lines 15, and second data lines 16.

The shift register unit 121 is connected to one row of pixels 10 through the gate line 13, to transmit the gate control signal to the pixel circuit in the pixel 10.

In a column of pixels, pixels in odd-numbered rows are connected to the same first data line 15, and pixels in even-numbered rows are connected to the same second data line 16.

In one embodiment, the display panel further includes a time division multiplexing circuit 14, the time division multiplexing circuit 14 includes input terminals IN and output terminal groups, one input terminal corresponds to at least one output terminal group, the output terminal group includes two output terminals respectively connected to the first data line 15 and the second data line 16, and the first data line 15 and the second data line 16 connected to the same output terminal group are connected to the same column of pixels.

The time division multiplexing circuit 14 is configured to control each input terminal IN to transmit a data voltage to each corresponding output terminal in a time division manner.

When a driver chip has fewer output ports and the display panel includes more columns of pixels, one output port of the driver chip may be connected to data lines of different columns of pixels through the time division multiplexing circuit 14 in a time division manner, to reduce the number of output ports of the driver chip. When the first scanning signal S1, the second scanning signal S2, and the third scanning signal S3 in the pixel circuit shown in FIG. 3 are generated by different gate drive circuits, each shift register unit 121 is connected to one gate line 13, to transmit the gate control signal to a row of pixels connected to the gate line 13. When the first scanning signal S1 and the second scanning signal S2 in the pixel circuit shown in FIG. 3 are generated by the same gate drive circuit, except that the first-stage shift register unit 121 and the last-stage shift register unit each are connected to one gate line 13, each of the remaining shift register units 121 is connected to two gate lines 13. The first-stage shift register unit and the last- stage shift register unit do not refer to a first-stage shift register unit and a last-stage shift register unit in a single gate drive circuit, but refer to a first-stage shift register unit and a last-stage shift register unit of all shift register units in all gate drive circuits. In this embodiment, as an example, two signal line groups and two gate drive circuits are included, and the gate control signal (i.e., the first scanning signal S1) output by an h^{th}-stage shift register unit to a second functional transistor of a pixel circuit in an h^{th} row of pixels connected is reused as the gate control signal (the second scanning signal S2) connected to a first functional transistor of a pixel circuit in an (h−2)^{th} row of pixels, to reduce the number of gate drive circuits, which is conducive to achieving a narrow bezel of the display panel, where h is an integer greater than or equal to 3. Further, the second functional transistor is a first initialization transistor M4 configured to initialize a gate of a drive transistor M1 in the same pixel circuit.

One column of pixels are connected to two data lines. Data writing processes for each odd-numbered row of pixels and each even-numbered row of pixels are performed continuously and alternately by using a Dual Data (dual data line) technology, and the data writing processes for the odd-numbered row and the even-numbered row do not affect each other, and the second scanning signals S2 of two adjacent rows of pixels may overlap, to increase the time for writing data. Based on the above time division electrical conduction function of the time division multiplexing circuit 14, a signal output from the input terminal IN can be written into the first data line 15 and the second data line 16 in a time division manner. In this way, the number of data channels of a driver IC or the number of driver ICs can be reduced, and data lines can be driven through a time division operation with fewer data channels, to achieve a higher refresh rate. This is more suitable for scenarios with higher refresh rate requirements.

Still referring to FIG. 5 and FIG. 6, in one embodiment, the time division multiplexing circuit 14 includes time division multiplexing modules 142, the time division multiplexing module includes at least one time division multiplexing unit 141, the time division multiplexing unit 141 is connected to one input terminal IN and one output terminal group, and each time division multiplexing unit 141 in the same time division multiplexing module is connected to the same input terminal IN.

The time division multiplexing circuit 14 further includes at least one gating signal line group 17, and one time division multiplexing unit 141 is connected to one gating signal line group 17. The gating signal line group 17 includes two gating signal lines, namely a first gating signal line MUX1 and a second gating signal line MUX2. A gating signal transmitted on the first gating signal line MUX1 is used to control whether the input terminal IN is connected to the corresponding first data line 15, and a gating signal transmitted on the second gating signal line MUX2 is used to control whether the input terminal IN is connected to the corresponding second data line 16.

In one embodiment, the time division multiplexing unit 141 may include, as shown in FIG. 5, a first gating transistor D1 and a second gating transistor D2, where the first gating transistor D1 is connected between the input terminal IN and the first data line 15, and the second gating transistor D2 is connected between the input terminal IN and the second data line 16. When the gating signal on the first gating signal line is an effective pulse, the first gating transistor D1 is controlled to be conducted, to connect the input terminal IN to the first data line 15. When the gating signal on the second gating signal line is an effective pulse, the second gating transistor D2 is controlled to be conducted, to connect the input terminal IN to the second data line 16. The effective pulse of the gating signal on the first gating signal line and the effective pulse of the gating signal on the second gating signal line in the same time division multiplexing unit 12 do not overlap, and the input terminal is connected to the first data line 15 and the second data line 16 in a time division manner.

In one embodiment, the time division multiplexing module includes at least two time division multiplexing units 141, different time division multiplexing units 141 in the same time division multiplexing module are connected to different gating signal line groups 17, and pixel columns corresponding to time division multiplexing units 141 in the same time division multiplexing module are arranged in sequence. In a process of writing data voltages corresponding to two adjacent rows of pixels 10 into the first data line and the second data line, pulses of gating signals transmitted on the first gating signal lines in the gating signal line groups are adjacent; and pulses of gating signals transmitted on the second gating signal lines in the gating signal line groups are adjacent. In the same time division multiplexing module, a pulse of the gating signals transmitted on the first gating signal line connected to the last time division multiplexing unit in timing sequence is adjacent to a pulse of the gating signals transmitted on the second gating signal line connected to the first time division multiplexing unit in timing sequence. That is, in the same time division multiplexing module, pulses of the gating signals on the first gating signal lines connected to the time division multiplexing units 141 are sequentially delayed by first set duration, pulses of the gating signals on the second gating signal lines connected to the time division multiplexing units are sequentially delayed by the first set duration, and in the same time division multiplexing module, a pulse of the gating signal on the second gating signal line connected to the first time division multiplexing unit in timing sequence is delayed by the first set duration from a pulse of the gating signal on the first gating signal line connected to the last time division multiplexing unit in timing sequence. The last time division multiplexing unit in timing sequence is a time division multiplexing unit corresponding to the last gating signal in timing sequence of all gating signals transmitted on the first gating signal lines, or a time division multiplexing unit corresponding to the last gating signal in timing sequence of all gating signals transmitted on the second gating signal lines. Similarly, the first time division multiplexing unit is a time division multiplexing unit corresponding to the first gating signal in timing sequence of all gating signals transmitted on the first gating signal lines, or a time division multiplexing unit corresponding to the first gating signal in timing sequence of all gating signals transmitted on the second gating signal lines. In one embodiment, pulses of any two gating signals do no overlap. In this embodiment, as an example, one time division multiplexing module includes two time division multiplexing units 141, one input terminal corresponds to two columns of pixels 10, and the gate control signal output by the odd-numbered stage shift register unit cooperates with the first clock signal line connected to each of two time division multiplexing units in the same time division multiplexing module, to write the data voltage into the odd-numbered row of pixel circuits. The gate control signal output by the even-numbered stage shift register unit cooperates with the gating signal on the second clock signal line connected to each of the two time division multiplexing units in the same time division multiplexing module, to write the data voltage into the even-numbered row of pixel circuits. In one embodiment, different time division multiplexing modules share a gating signal line group. When the time division multiplexing circuit includes time division multiplexing modules, different time division multiplexing modules are connected to the same clock signal line group. For example, if each time division multiplexing module includes two time division multiplexing units, and the display panel includes two gating signal line groups, each time division multiplexing module is connected to the two gating signal line groups.

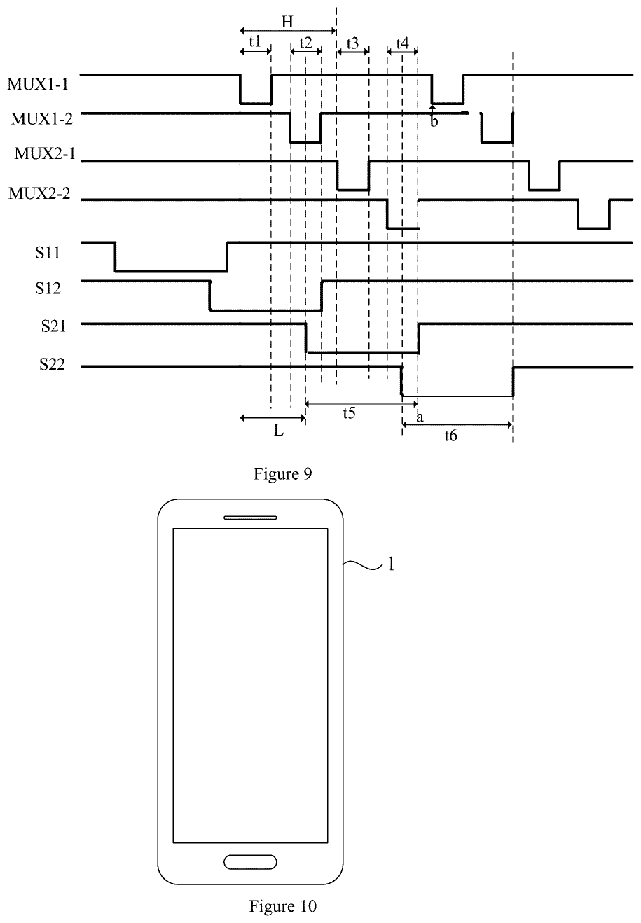

FIG. 9 is a driving timing sequence diagram of a display panel according to an embodiment of the present disclosure. An example in which each transistor included in the multiplexing unit 141 is an N-type transistor is used, and an effective potential of the gating signal is at a low level. Referring to FIG. 3, FIG. 5, and FIG. 9, an operation process of the display panel is as follows.

In a first phase t1, a gating signal on a first gating signal line MUX1-1 corresponding to a first column of pixels is at a low level, and a first gating transistor T1 that is connected to a first data line 15 connected to the first column of pixels is controlled to be conducted, to transmit a data signal input at the input terminal IN to the first data line 15 connected to a pixel in the first row and the first column. Each first data line 15 is further connected to a corresponding storage unit having a voltage storage function, to store the data signal on the first data line 15 after the first gating transistor T1 is cut off.

In a second phase t2, a gating signal on a first gating signal line MUX1-2 corresponding to a second column of pixels is at a low level, and a first gating transistor T1 that is connected to a first data line 15 connected to the second column of pixels is controlled to be conducted, to transmit the data signal input at the input terminal IN to the first data line 15 connected to a pixel in the first row and the second column.

In a third phase t3, a gating signal on a second gating signal line MUX2-1 corresponding to the first column of pixels is at a low level, and a second gating transistor T2 that is connected to a second data line 16 connected to the first column of pixels is controlled to be conducted, to transmit the data signal input at the input terminal IN to the second data line 16 connected to a pixel in the second row and the first column. Each second data line 16 is further connected to a corresponding storage unit having a voltage storage function, to store the data signal on the second data line 16 after the second gating transistor T2 is cut off.

In a fourth phase t4, a gating signal on a second gating signal line MUX2-2 corresponding to the second column of pixels is at a low level, and a second gating transistor T2 that is connected to a second data line 16 connected to the second column of pixels is controlled to be conducted, to transmit the data signal input at the input terminal IN to the second data line 16 connected to a pixel in the second row and the second column.

The first phase t1 to the fourth phase t4 are repeated to achieve full-screen charging through the data lines. A gating signal line corresponding to a column of pixels is a gating signal line that is connected to a gate of a gating transistor connected to a data line connected to the column of pixels.

In a fifth phase t5, a second scanning signal S21 connected to a first row of pixels is at a low level, and the data write transistor M2 and the compensation transistor M3 are controlled to be conducted, to write a data voltage transmitted on each first data line 15 connected to the first row of pixels in the first phase t1 and the second phase t2 into the drive transistor M1.

In a sixth phase t6, a second scanning signal S22 connected to a second row of pixels is at a low level, and the data write transistor M2 and the compensation transistor M3 are controlled to be conducted, to write a data voltage transmitted on each second data line 16 connected to the second row of pixels in the first phase t1 and the second phase t2 into the drive transistor M1.

An effective pulse of a first scanning signal S11 connected to the first row of pixels precedes the second scanning signal S21 connected to the first row of pixels. An effective pulse of a first scanning signal S12 connected to the second row of pixels precedes the second scanning signal S22 connected to the second row of pixels, to write the data voltage after the writing of a first initialization voltage ends.

Effective pulses of gate control signals correspondingly connected to functional transistors of the same type of pixel circuits in two adjacent rows of pixels overlap. For example, effective pulses of the second scanning signals S2 correspondingly connected to pixel circuits in two adjacent rows for controlling the data write transistor M2 to be conducted overlap. The fifth phase t5 and the sixth phase t6 overlap. In two adjacent rows of pixels, before the writing of the data voltage into the drive transistor M1 for a previous row of pixels ends, the writing of the data voltage into the drive transistor M1 for a next row of pixels can start, to increase the time for writing the data voltage. In this way, the writing of the data voltage is more sufficient.

In one embodiment, an end moment of an effective pulse of a gate control signal received by a data write transistor of a pixel circuit in an n^{th} row of pixels coincides with or is earlier than a first moment. At the first moment, a data line connected to an (n+2)^{th} row of pixels starts charging; or, at the first moment, a k^{th} data line and a corresponding input terminal begin to connect to transmit a data signal corresponding to an (n+2)^{th} row of pixels. In one embodiment, n is a positive integer; n is an odd number, the k^{th} data line is the first data line; or n is an even number, the k^{th} data line is the second data line. The end moment of the effective pulse of the gate control signal received by the data write transistor of the pixel circuit in the n^{th} row of pixels is after the moment at which the data line connected to the (n+2)^{th} row of pixels starts charging. In this case, when the nth row of pixels is still in the process of writing the data voltage corresponding to the n^{th} row of pixels into the drive transistor M1, the voltage on the data line connected to the n^{th} row of pixels has jumped to the data voltage corresponding to the (n+2)^{th} row of pixels, resulting in an inaccurate data voltage written into the drive transistor M1 of the first row of pixels, which affects the display effect. In one embodiment, a time interval between the end moment of the effective pulse of the gate control signal connected to the data write transistor M2 of the pixel circuit in the n^{th} row of pixels and the moment at which the data line connected to the (n+2)^{th} row of pixels starts charging is less than set duration. Shorter set duration indicates longer duration of the effective pulse of the gate control signal and more sufficient writing of the data voltage into the drive transistor M1. In one embodiment, the set duration is 0. In one embodiment, the n^{th} row of pixels are connected to a k^{th} data line, where k is 1 or 2. The moment at which the data line starts charging is a start moment of an effective pulse of a first k^{th} gating signal line in timing sequence connected to a time division multiplexing unit 121 corresponding to the k^{th} data line connected to the n^{th} row of pixels. The first k^{th} gating signal line in timing sequence is a k^{th} gating signal line connected to the first time division multiplexing unit 121 in timing sequence in the same time division multiplexing module. When the data line connected to the n^{th} row of pixels is the first data line 15, k is 1, and when the data line connected to the n^{th} row of pixels is the second data line 16, k is 2.

The first row of pixels are used as an example. The first row of pixels are connected to the first data line 15, and an end moment a of an effective pulse of a second scanning signal S21 received by a data write transistor M2 of a pixel circuit in the first row of pixels coincides with or is earlier than a first moment b at which the transmission of a second effective pulse starts on the first gating signal line MUX1-1 corresponding to the first column of pixels.

In one embodiment, a time period to which an effective pulse of the last k^{th} gating signal line in timing sequence connected to the time division multiplexing unit corresponding to the k^{th} data line connected to an (n+1)^{th} row of pixels belongs is within a time period to which the effective pulse of the gate control signal connected to the data write transistor of the pixel circuit in the n^{th} row of pixels belongs, where k is 1 or 2. The last k^{th} gating signal line in timing sequence is a k^{th} gating signal line connected to the last time division multiplexing unit in timing sequence in the same time division multiplexing module. Corresponding to FIG. 9, i.e. the fourth phase t4 is within the fifth phase t5, and after the data writing of the (n+1)^{th} row of pixels is completed, the writing of the data voltage on the data line into the drive transistor is still performed for the n^{th} row of pixels, or the writing of the data voltage on the data line into the drive transistor for the n^{th} row of pixels just ends, to start the writing of the data voltage on the data line into the drive transistor for the (n+1)^{th} row of pixels as early as possible.

A time period during which an e^{th} data line and a corresponding input terminal connect to transmit a data signal corresponding to an (n+1)^{th} row of pixels is within a time period during which the gate control signal received by the data write transistor of the pixel circuit in the n^{th} row of pixels has the effective pulse; and n is an odd number, the e^{th} data line is the second data line; or n is an even number, the e^{th} data line is the first data line. Referring to FIG. 9, the time period during which the e^{th} data line and the corresponding input terminal connect to transmit a data signal corresponding to an (n+1)^{th} row of pixels includes the third phase t3 and the fourth phase t4, the time period during which the gate control signal received by the data write transistor of the pixel circuit in the n^{th} row of pixels has the effective pulse is the fifth phase t5.

Still referring to FIG. 3, FIG. 5, and FIG. 9, in one embodiment, the effective pulse of the gate control signal received by the data write transistor M2 of the pixel circuit in the n^{th} row of pixels overlaps charging time of the data line connected to the n^{th} row of pixels, where n is a positive integer. The charging time of the data line connected to the n^{th} row of pixels is: a time interval between a moment at which the input terminal IN of the time division multiplexing circuit starts transmitting the data voltage corresponding to the first column of pixels in the n^{th} row of pixels to the data line connected to this column of pixels and a moment at which the input terminal IN of the time division multiplexing circuit ends transmitting the data voltage corresponding to the last column of pixels in the n^{th} row of pixels to the data line connected to this column of pixels. Compared with the case in which after voltages on the data lines connected to each columns of pixels in a row of pixels are prepared, the data voltages of the columns in this row start to be written into the drive transistor M1 in the corresponding pixel circuit, in this embodiment, the gate control signal connected to the n^{th} row of pixels is controlled to be an effective pulse at least before the input terminal IN of the time division multiplexing circuit in the n^{th} row of pixels ends transmitting the data voltage corresponding to the last column to the data line connected to the last column of pixels, and the n^{th} row of pixels start transmitting the data voltage corresponding to this row and written into each column to the drive transistor M1 in the pixel circuit, to greatly shorten the time for writing the data voltage into the drive transistor M1. In this way, the writing of the data voltage is more sufficient, the problems of image sticking and uneven display at a low gray scale are alleviated, and the display effect is improved.

In one embodiment, the n^{th} row of pixels is connected to a k^{th} data line, where k is 1 or 2.

The effective pulse of the gate control signal connected to the data write transistor M2 of the pixel circuit in the n^{th} row of pixels overlaps the effective pulse of the last k^{th} gating signal line in timing sequence. The last k^{th} gating signal line in timing sequence is a k^{th} gating signal line connected to the last time division multiplexing unit 141 in timing sequence in the same time division multiplexing module. When n is an odd number, k is 1, and when n is an even number, k is 2. For example, when the display panel includes a total of 50 columns of pixels, the last k^{th} gating signal line in timing sequence is a gating signal line that corresponds to a time division multiplexing unit 141 corresponding to a data line connected to the 50^{th} column of pixels, namely the last column of pixels. For example, if the time division multiplexing module includes two time division multiplexing units, where n is an odd number, the last k^{th} gating signal line in timing sequence is a first gating signal line MUX1-2 corresponding to the second column of pixels in two columns of pixels corresponding to the time division multiplexing module. The effective pulse of the gate control signal connected to the data write transistor M2 of the pixel circuit in the n^{th} row of pixels overlaps the effective pulse of the last k^{th} gating signal line in timing sequence, to increase the time for writing the data voltage. In this way, the writing of the data voltage is more sufficient. Further, a start moment of the effective pulse of the gate control signal received by the data write transistor of the pixel circuit in the n^{th} row of pixels is later than or coincides with a start moment of the first effective pulse of the last k^{th} gating signal line in timing sequence, to further increase the time for writing the data voltage, to ensure that the writing of the data voltage is more sufficient. In one embodiment, an interval L between the start moment of the effective pulse of the gate control signal connected to the data write transistor M2 of the pixel circuit in the n^{th} row of pixels and a moment at which the pixel circuit in the n^{th} row of pixels starts writing the data voltage into the drive transistor M1 is greater than 0.5 H, where H is a row period.

The time period during which the gate control signal received by the data write transistor of the pixel circuit in the n^{th} row of pixels has the effective pulse overlaps a first time period during which the k^{th} data line and the corresponding input terminal connect to transmit a data signal corresponding to an n^{th} row of pixels. The effective pulse of the gate control signal received by the data write transistor of the pixel circuit in the n^{th} row of pixels overlaps a first effective pulse of the last k^{th} gating signal line, the first effective pulse of the last k^{th} gating signal line is located within the first time period, and the last k^{th} gating signal line is the k^{th} gating signal line connected to the last time division multiplexing unit in the same time division multiplexing module. Referring to FIG. 9, the time period during which the gate control signal received by the data write transistor of the pixel circuit in the n^{th} row of pixels has the effective pulse is the fifth phase t5, and the first time period during which the k^{th} data line and the corresponding input terminal connect to transmit a data signal corresponding to an n^{th} row of pixels includes the first phase t1 and the second phase t2. The first effective pulse of the last k^{th} gating signal line corresponds to the second phase t2.

Still referring to FIG. 3, FIG. 5, and FIG. 9, in one embodiment, a difference between pulse widths (i.e., t1, t2, t3, and t4) of gating signals transmitted on any two gating signal lines is less than a set width threshold. In one embodiment, the set width threshold is greater than or equal to 0, and less than or equal to three percent of a ratio of an absolute value of a difference between a pulse width of a previous gating signal and a pulse width of a next gating signal to the pulse width of the previous gating signal, where the previous gating signal and the next gating signal are two gating signals adjacent in timing sequence. A smaller pulse width of the gating signal indicates shorter time for writing the data voltage into the corresponding drive transistor M1, and a larger pulse width of the gating signal indicates longer time for writing the data voltage into the corresponding drive transistor M1. If pulse widths of gating signals corresponding to two gating signal lines in the same time division multiplexing unit 121 differ greatly, the time for writing the data voltage into the drive transistor M1 in different columns of pixels in the same row differs greatly, resulting in different degrees of writing the data voltage, and in turn resulting in uneven display. Therefore, in this embodiment, the difference between the pulse widths of the gating signals transmitted on any two gating signal lines is set to be less than the set width threshold, to ensure the same time for writing the data voltage into the drive transistors M1 in different pixels and the same degree of writing the data voltage, to alleviate the uneven display and improving the display effect.

In one embodiment, duration of the effective pulse of the gate control signal is greater than a row period, where the row period is related to a refresh rate and resolution of the display panel. The row period is equal to 1/refresh rate/equivalent number of rows of subpixels, where the equivalent number of rows of subpixels may be obtained based on the resolution of the display panel. Specifically, the actual number of rows of subpixels in the display panel and the dummy number of rows of subpixels corresponding to blanking time may be determined based on the resolution of the display panel, where the actual number of rows of subpixels is the actual number of rows of subpixels included in the display panel. The blanking time may be signal switching time between frames. The signal switching time corresponds to a specific number of dummy rows of subpixels, that is, the signal switching time is equal to the total time for outputting an effective scanning signal to the dummy rows of subpixels, and the dummy rows of pixels do not exist in the display panel. The equivalent number of rows of subpixels is equal to a sum of the actual number of rows of subpixels and the dummy number of rows of subpixels. For example, the row period H is 4.6 μs and the duration of the effective pulse of the gating signal on each gating signal line is 1.8 μs. The effective pulse of the gate control signal connected to the data write transistor M2 of the pixel circuit in the n^{th} row of pixels overlaps the effective pulse of the last k^{th} gating signal line in timing sequence, and the end moment of the effective pulse of the gate control signal connected to the data write transistor M2 of the pixel circuit in the n^{th} row of pixels coincides with or is earlier than the moment at which the data line connected to the (n+2)^{th} row of pixels starts charging, and the duration of the effective pulse of the gate control signal is greater than the row period, for example, may reach 5.6 μs, to ensure that the writing of the data voltage is more sufficient, alleviating the image sticking and the uneven display at a low gray scale, and greatly improving the optical display performance.

An embodiment of the present disclosure further provides another display panel. Still referring to FIG. 2, the display panel includes pixels 10 and gate drive circuits 12.

Each gate drive circuit 12 includes shift register units 121 cascade-connected in sequence, and each shift register unit 121 is connected to at least one row of pixels. The shift register unit 121 is configured to output a gate control signal to a row of pixels connected, and effective pulses of gate control signals output by the shift register units 121 connected to adjacent rows of pixels overlap, and a data voltage is written into the adjacent rows of pixels simultaneously for at least some duration, to increase the time for writing the data voltage and improving the display effect.

An embodiment of the present disclosure further provides a display module, including the display panel according to any one of the above embodiments. The display module has the same beneficial effects as the display panel, and details are not repeated. The display module may further include a polarizer, a touch panel, etc.

An embodiment of the present disclosure further provides a display apparatus. FIG. 10 is a schematic diagram of a structure of a display apparatus according to an embodiment of the present disclosure. The display apparatus 1 includes the display module in the above embodiment. The display apparatus 1 may be a mobile phone shown in FIG. 10, or may be a computer, a television, a smart wearable display apparatus, etc., which is not specifically limited in this embodiment of the present disclosure. The display apparatus has the same beneficial effects as the display module, and details are not described herein again.

It should be understood that steps may be reordered, added, or deleted using the various forms of flows shown above. For example, the steps recorded in the present disclosure may be performed in parallel, sequentially, or in a different order, provided that the desired results of the embodiments of the present disclosure can be achieved, which are not limited herein.

The above specific implementations do not constitute a limitation on the scope of protection of the present disclosure. Various modifications, combinations, sub-combinations, and replacements can be made based on design requirements and other factors. Any modification, equivalent replacement, improvement, etc. made within the spirit and principles of the present disclosure shall fall within the scope of protection of the present disclosure.

What is claimed is:

1. A display panel, comprising:
a plurality of pixels, comprising a plurality of rows of pixels;
a plurality of clock signal line groups, each clock signal line group comprising a first clock signal line and a second clock signal line; and
a plurality of gate drive circuits corresponding to the plurality of clock signal line groups, wherein each gate drive circuit comprises a plurality of shift register units cascade-connected in sequence, each shift register unit is connected to at least one of the plurality of rows of pixels, and each shift register unit in each gate drive circuit is connected to the first clock signal line and the second clock signal line in the corresponding clock signal line group;
wherein in the clock signal line groups, pulses of first clock signals transmitted on the first clock signal lines are sequentially delayed by a preset duration, and the pulses of the first clock signals transmitted on two adjacent first clock signal lines overlap; and
in the clock signal line groups, pulses of second clock signals transmitted on the second clock signal lines are sequentially delayed by the preset duration, and the pulses of the second clock signals transmitted on two adjacent second clock signal lines overlap.

2. The display panel according to claim 1, wherein each one of the plurality of pixels comprises a pixel circuit comprising a first functional transistor, the shift register unit is configured to output a gate control signal to the first functional transistor of the pixel circuit in the row of pixels, effective pulses of gate control signals output by shift register units connected to adjacent rows of pixels overlap, the shift register units connected to the adjacent rows of pixels are located in different gate drive circuits, and the first functional transistor is a data write transistor.

3. The display panel according to claim 2, wherein the pixel circuit further comprises a first initialization transistor and a drive transistor, a first scanning signal output by an h^{th}-stage shift register unit to the first initialization transistor of the pixel circuit in an h^{th} row of pixels is reused as the gate control signal received by the first functional transistor of the pixel circuit in an (h−2)^{th} row of pixels, h is greater than or equal to 3; and the first initialization transistor is configured to initialize a gate of the drive transistor in the same pixel circuit.

4. The display panel according to claim 2, wherein the effective pulse of the gate control signal output by the shift register unit connected to an n^{th} row of pixels and the effective pulse of the gate control signal output by the shift register unit connected to an (n+2)^{th} row of pixels are set at an interval, wherein n is a positive integer; the shift register unit connected to the n^{th} row of pixels and the shift register unit connected to the (n+2)^{th} row of pixels are located in the same gate drive circuit.

5. The display panel according to claim 2, wherein the display panel comprises f clock signal line groups and f gate drive circuits, and an (fm+q)^{th} row of pixels is connected to a q^{th} gate drive circuit, wherein m is an integer greater than or equal to 0, and q is a positive integer greater than or equal to 1 and less than or equal to f.

6. The display panel according to claim 2, wherein each shift register unit comprises a first clock signal terminal and a second clock signal terminal;
in the same gate drive circuit, the first clock signal terminal of a (2i+1)^{th} shift register unit is connected to the first clock signal line in the clock signal line group corresponding to the gate drive circuit, and the second clock signal terminal of the (2i+1)^{th} shift register unit is connected to the second clock signal line in the clock signal line group corresponding to the gate drive circuit; and
the first clock signal terminal of a (2i+2)^{th} shift register unit is connected to the second clock signal line in the clock signal line group corresponding to the gate drive circuit, and the second clock signal terminal of the (2i+2)^{th} shift register unit is connected to the first clock signal line in the clock signal line group corresponding to the gate drive circuit, wherein i is an integer greater than or equal to 0.

7. The display panel according to claim 2, wherein the display panel comprises two clock signal line groups and two gate drive circuits, one of the two gate drive circuits comprises odd-numbered stage shift register units, and the other one of the two gate drive circuits comprises even-numbered stage shift register units; and
each odd-numbered stage shift register unit is correspondingly connected to an odd-numbered row of pixels, and each even-numbered stage shift register unit is connected to an even-numbered row of pixels.

8. The display panel according to claim 2, wherein the pulse of the first clock signal transmitted on the first clock signal line in the last clock signal line group is adjacent to and overlaps the pulse of the second clock signal transmitted on the second clock signal line in a first clock signal line group, and the pulse of the second clock signal transmitted on the second clock signal line in the first clock signal line group is delayed by the preset duration compared with the pulse of the first clock signal transmitted on the first clock signal line in the last clock signal line group;
or the pulse of the second clock signal transmitted on the second clock signal line in the last clock signal line group is adjacent to and overlaps the pulse of the first clock signal transmitted on the first clock signal line in a first clock signal line group, and the pulse of the first clock signal transmitted on the first clock signal line in the first clock signal line group is delayed by preset duration compared with the pulse of the second clock signal transmitted on the second clock signal line in the last clock signal line group.

9. The display panel according to claim 2, further comprising a plurality of gate lines, a plurality of first data lines, and a plurality of second data lines, and the plurality of pixels comprising a plurality of columns of pixels;
Wherein the shift register unit is connected to the row of pixels through the gate line transmitting a gate control signal to a pixel circuit in the pixel; in the column of pixels, the pixels in odd-numbered rows are connected to the same first data line, and the pixels in even-numbered rows are connected to the same second data line.

10. The display panel according to claim 9, further comprises a time division multiplexing circuit, wherein the time division multiplexing circuit comprises a plurality of input terminals and a plurality of output terminal groups, one input terminal corresponds to at least one output terminal group, the output terminal group comprises two output terminals respectively connected to the first data line and the second data line, and the first data line and the second data line connected to the same output terminal group are connected to the same column of pixels; and the time division multiplexing circuit is configured to control each input terminal to transmit a data voltage to each corresponding output terminal in a time division manner.

11. The display panel according to claim 10, wherein the time division multiplexing circuit comprises a plurality of time division multiplexing modules, the time division multiplexing module comprises at least one time division multiplexing unit, the time division multiplexing unit is connected to one input terminal and one output terminal group; and
the time division multiplexing circuit further comprises at least one gating signal line group, and one time division multiplexing unit is connected to one gating signal line group; the gating signal line group comprises a first gating signal line and a second gating signal line; a gating signal transmitted on the first gating signal line is used to control whether the input terminal is connected to a corresponding first data line, and a gating signal transmitted on the second gating signal line is used to control whether the input terminal is connected to a corresponding second data line.

12. The display panel according to claim 11, wherein the time division multiplexing module comprises at least two time division multiplexing units, different time division multiplexing units in the same time division multiplexing module are connected to different gating signal line groups and the same input terminal, and the columns of pixels corresponding to the at least two time division multiplexing units in the same time division multiplexing module are arranged in sequence.

13. The display panel according to claim 11, wherein during a process of writing data voltages corresponding to two adjacent rows of pixels into the first data line and the second data line, pulses of the gating signals transmitted on the first gating signal lines in each gating signal line group are adjacent, and pulses of the gating signals transmitted on the second gating signal lines in each gating signal line group are adjacent.

14. The display panel according to claim 13, wherein in the same time division multiplexing module, the pulse of the gating signal transmitted on the first gating signal line connected to the last time division multiplexing unit is adjacent to the pulse of the gating signal transmitted on the second gating signal line connected to a first time division multiplexing unit.

15. The display panel according to claim 11, wherein an end moment of the effective pulse of the gate control signal received by the data write transistor of the pixel circuit in an n^{th} row of pixels coincides with or is earlier than a first moment at which a k^{th} data line and a corresponding input terminal begin to connect to transmit a data signal corresponding to an (n+2)^{th} row of pixels, wherein n is a positive integer; and
n is an odd number, the k^{th} data line is the first data line; or n is an even number, the k^{th} data line is the second data line.

16. The display panel according to claim 15, wherein a time period during which an e^{th} data line and a corresponding input terminal connect to transmit a data signal corresponding to an (n+1)^{th} row of pixels is within a time period during which the gate control signal received by the data write transistor of the pixel circuit in the n^{th} row of pixels has the effective pulse; and
n is an odd number, the e^{th} data line is the second data line; or n is an even number, the e^{th} data line is the first data line.

17. The display panel according to claim 16, wherein the time period during which the gate control signal received by the data write transistor of the pixel circuit in the n^{th} row of pixels has the effective pulse overlaps a first time period during which the k^{th} data line and the corresponding input terminal connect to transmit a data signal corresponding to an n^{th} row of pixels.

18. The display panel according to claim 17, wherein the effective pulse of the gate control signal received by the data write transistor of the pixel circuit in the n^{th} row of pixels overlaps a first effective pulse of the last k^{th} gating signal line, the first effective pulse of the last k^{th} gating signal line is located within the first time period, wherein the last k^{th} gating signal line is the k^{th} gating signal line connected to the last time division multiplexing unit in the same time division multiplexing module.

19. The display panel according to claim 18, wherein a start moment of the effective pulse of the gate control signal received by the data write transistor of the pixel circuit in the n^{th} row of pixels is later than or coincides with a start moment of the first effective pulse of the last k^{th} gating signal line.

20. A display panel, comprising:
a plurality of pixels, comprising a plurality of rows of pixels; and
a plurality of gate drive circuits, wherein each gate drive circuit comprises a plurality of shift register units cascade-connected in sequence, and each shift register unit is connected to at least one row of pixels; and the shift register unit is configured to output a gate control signal to the row of pixels, and effective pulses of the gate control signals output by the shift register units connected to adjacent rows of pixels overlap.
